(19) United States
(12) Patent Application Publication
(10) Pub. No.: US 2003/0081261 A1
(43) Pub. Date: May 1, 2003

(54) Communication terminal device

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA MACHINERY, LTD.

(21) Appl. No.: 10/271,860

(22) Filed: Oct. 16, 2002

(30) Foreign Application Priority Data
Oct. 30, 2001 (JP) 2001-332309

(51) Int. Cl. H04N 1/00

(52) U.S. Cl. 358/400; 358/402

(57) ABSTRACT

A communication terminal device includes a receiving unit for receiving data via a network and a printing unit for printing the data on a recording paper after carrying out a warm up operation. A control unit controls to start t he warm up operation of the printing unit prior to receiving of the data and starts printing of the data on the recording paper after receiving the data and the warm up operation has been completed.

### FIELD OF THE INVENTION

The present invention relates to a communication terminal device, for example, a facsimile machine, a digital multifunction peripheral, or the like, which includes a printing unit such as an electro-photographic type printer that performs a printing operation on a recording paper after performing a warm-up operation.

### DESCRIPTION OF THE RELATED ART

For printing received image data, text data such as a speed-dial list or a delivery failure report, on a recording paper, a conventional facsimile machine includes a printer. The printer can be any one of various types of printers, for example, electro-photographic type, inkjet type, thermal transfer type, or thermal paper type. The electro-photographic type printer uses toner for developing, and carries out heat fusing by a heater. The inkjet type printer carries out printing by using print ink. The thermal transfer type printer and the thermal paper type printer carry out printing by using a thermal head.

For reducing power consumption, the facsimile machine including the electro-photographic type printer stops heater of a fuser, or sets a temperature low during standby. Then, when printing, the facsimile machine warms up and maintains a prescribed temperature.

The above-mentioned warming up operation requires some time. Therefore, G3 facsimile machine or the like starts warming up after detecting an incoming call. However, there are cases when unnecessary warming up is carried out, for example, when receiving data that is not necessary to be printed.

### SUMMARY OF THE INVENTION

An advantage of the present invention is to solve the above-mentioned problem, and to provide a communication terminal device that can eliminate unnecessary warming up, reduce power consumption, and reduce printing time.

According to a first aspect of the present invention, the communication terminal device includes a printing unit for carrying out printing on a recording paper after carrying out a warm up operation. In addition, the communication terminal device includes a control means for controlling to start the warm up operation of the printing unit when detecting electronic mail that is to be downloaded, and to start printing of the electronic mail on a recording paper after the download of the electronic mail and the warm up operation are completed.

According to the first aspect of the present invention, by carrying out most suitable warm up operations of the printing unit, unnecessary warm up operations can be eliminated, the power consumption can be reduced, and the printing time can be reduced.

According to a second aspect of the present invention, the communication terminal device includes a printing unit for carrying out printing on a recording paper after carrying out a warm up operation. In addition, the communication terminal device includes a control means for controlling to start the warm up operation of the printing unit when detecting a reception of an electronic mail, and to start printing of the electronic mail on a recording paper after the reception of the electronic mail and the warm up operation are completed.

According to the second aspect of the present invention, by carrying out most suitable warm up operations of the printing unit, unnecessary warm up operations can be eliminated, the power consumption can be reduced, and the printing time can be reduced.

According to a third aspect of the present invention, the communication terminal device includes a printing unit for carrying out printing on a recording paper after carrying out a warm up operation. In addition, the communication terminal device includes a determining means for determining whether or not to print out data in accordance with a prescribed condition table, prior to receiving of the data. Furthermore, the communication terminal device includes a control means for controlling to start the warm up operation of the printing unit when it is determined that printing is necessary, and to start printing of the data on a recording paper after the reception of the data and the warm up operation are completed.

According to the third aspect of the present invention, unnecessary warm up operations can be eliminated, power consumption can be reduced, and printing time can be reduced.

According to a fourth aspect of the present invention, the communication terminal device includes a printing unit for carrying out printing on a recording paper after carrying out a warm up operation. In addition, the communication terminal device includes a plurality of receiving means for receiving data. The communication terminal device also includes a determining means for determining whether or not to print out data in accordance with a prescribed condition table. The communication terminal device also includes a control means for controlling to start the warm up operation of the printing unit when it is determined that printing is necessary, and to start printing of the data on a recording paper after the warm up operation is completed. The communication terminal device also includes a changing means for changing the time to carry out determination by the determining means, either to before receiving the data or after receiving the data.

According to the fourth aspect of the present invention, unnecessary warm up operations can be eliminated, power consumption can be reduced, and printing time can be reduced.

According to a fifth aspect of the present invention, the communication terminal device includes a printing unit for carrying out printing on a recording paper after carrying out a warm up operation. In addition, the communication terminal device includes a determining means for determining whether or not to print out data in accordance with a prescribed condition table. The communication terminal device also includes a first control means for controlling to start the warm up operation of the printing unit when it is determined that printing is necessary, and to start printing of the data on a recording paper after the warm up operation is completed. The communication terminal device also includes a second control means for controlling to start the warm up operation of the printing unit without determination by the determining means, and to start printing of the data on a recording paper after the warm up operation is completed. In addition, the communication terminal device includes a setting means for setting, by selectively switching between a processing by the first control means and a processing by the second control means.

According to the fifth aspect of the present invention, the communication terminal device is preferable to also include a plurality of receiving means for receiving the data. In addition, it is preferable for the setting means to set by switching selectively between the processing by the first control means and the processing by the second control means in accordance with the plurality of receiving means.

According to the fifth aspect of the present invention, by carrying out most suitable warm up operations of the printing unit, unnecessary warm up operations can be eliminated, power consumption can be reduced, and printing time can be reduced. In addition, the user can set timing of the warm up operation of the printing unit. As a result, the most suitable warm up operation can be carried out in accordance with type of usage of user, and energy savings can be improved.

In addition, by carrying out the most suitable warm up operation of the printing unit in accordance with the plurality of the receiving means, unnecessary warming up of the printing unit can be eliminated, power consumption can be reduced, and printing time can be reduced.

### BRIEF DESCRIPTION OF THE DRAWINGS

FIG. 1 is a block diagram showing a structure of LAN system including a digital multifunction peripheral 20 which is a facsimile machine with copy, printer, and scanner functions, according to an embodiment of the present invention.

FIG. 2 is a block diagram showing a structure of a client PC 30 of FIG. 1.

FIG. 3 is a block diagram showing a structure of the digital multifunction peripheral 20 of FIG. 1.

FIG. 4 is a view showing an example of distribution condition table 7a which is stored in RAM 7 of FIG. 3.

FIG. 5 is a flowchart showing POP receiving processing according to an embodiment of the present invention that is to be carried out by a main control unit 1 of the digital multifunction peripheral 20 of FIG. 3.

FIG. 6 is a flowchart showing SMTP receiving processing according to an embodiment of the present invention that is to be carried out by the main control unit 1 of the digital multifunction peripheral 20 of FIG. 3.

FIG. 7 is a flowchart showing POP receiving processing according to the second embodiment of the present invention that is to be carried out by a main control unit 1 of the digital multifunction peripheral 20 of FIG. 3.

FIG. 8 is a flowchart showing SMTP receiving processing according to the second embodiment of the present invention that is to be carried out by the main control unit 1 of the digital multifunction peripheral 20 of FIG. 3.

FIG. 9 is a flowchart showing G3FAX receiving processing according to the second embodiment of the present invention that is to be carried out by the main control unit 1 of the digital multifunction peripheral 20 of FIG. 3.

### DETAILED DESCRIPTION OF THE PREFERRED EMBODIMENTS

An embodiment of the present invention will be described in accordance with accompanying drawings.

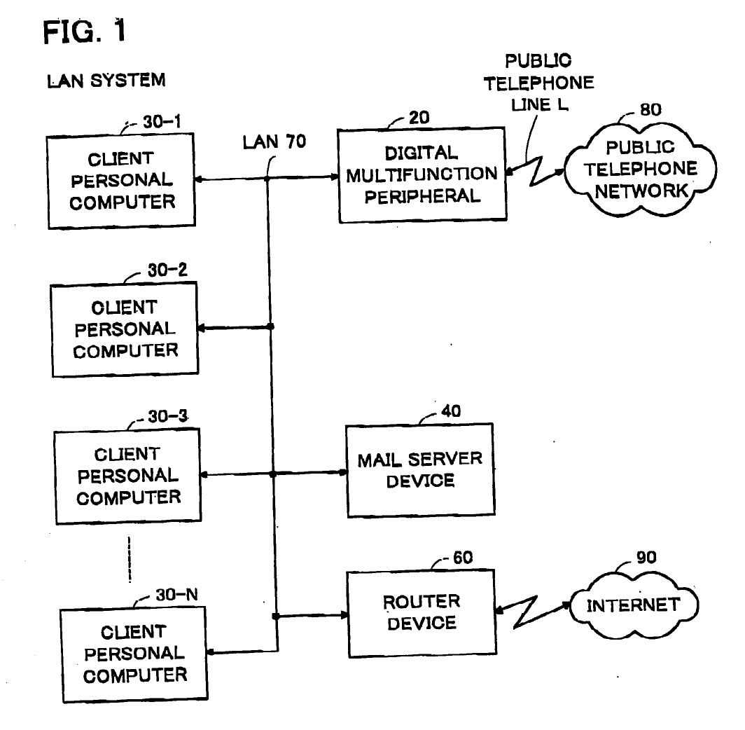

FIG. 1 is a block diagram showing a structure of a LAN (Local Area Network) system including a digital multifunction peripheral 20 which is a facsimile machine with copy, network printer, and network scanner functions, according to an embodiment of the present invention.

The LAN system according to the present embodiment is formed with a plural numbers of N client personal computers (hereinafter referred to as the client PC) 30-1 through 30-N (hereinafter generically referred to as the client PC 30), the digital multifunction peripheral 20, and a router device 60 being connected via LAN 70. The digital multifunction peripheral 20 is connected to a public telephone network 80 via a public telephone line L. The router device 60 is connected to Internet 90. By accessing to the Internet 90 via the router device 60 or a mail server device 40 from each client PC 30, home pages can be viewed, and electronic mails can be transmitted and received. In addition, when each client PC 30 accesses to the digital multifunction peripheral 20, the client PC 30 can use each of the functions of the digital multifunction peripheral 20, the copy function, the network printer function, the network scanner function, and the facsimile function.

The digital multifunction peripheral 20 according to the present embodiment includes an Internet facsimile function for receiving electronic mails by POP (Post Office Protocol) 3 procedure or SMTP (Simple Mail Transfer Protocol) procedure, and transmitting electronic mails by the SMTP procedure. In addition, the digital multifunction peripheral 20 includes an electro-photographic type printer 3, which has a heater at a fuser, and which carries out printing to a recording paper after carrying out a warm up operation of the heater. In the case of receiving the electronic mail by the POP3 procedure, a main control unit 1 controls to start the warm up operation of the fuser of the printer 3 when detecting the electronic mail that is to be downloaded. Then, after downloading of the electronic mail and warm up operation are completed, the main control unit 1 controls to start printing the electronic mail to the recording paper.

In addition, in the case of receiving the electronic mail by the SMTP procedure, the main control unit 1 controls to start the warm up operation of the fuser of the printer 3 when detecting the reception of an electronic mail. Then, after receiving of the electronic mail and the warm up operation are completed, the main control unit 1 controls to start printing the electronic mail to the recording paper.

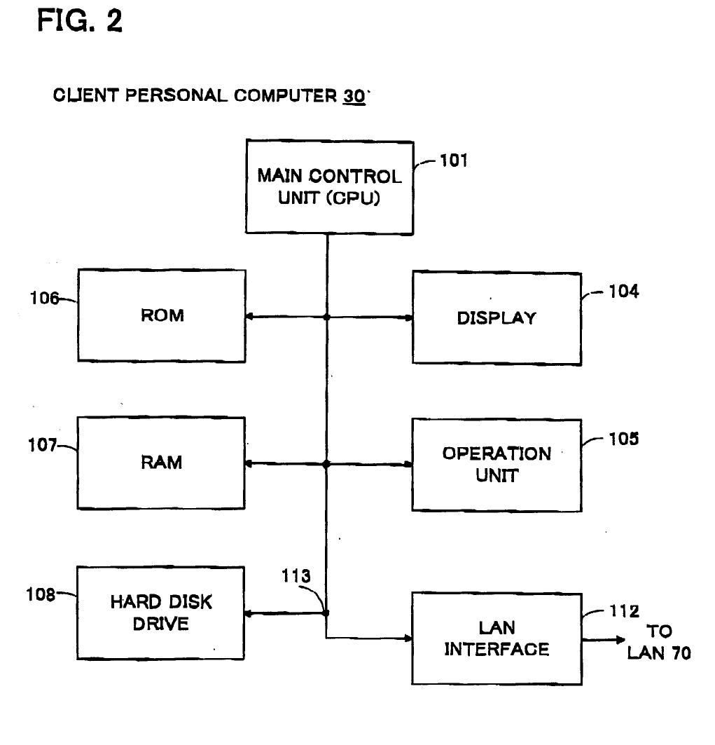

FIG. 2 is a block diagram showing the structure of the client PC 30 of FIG. 1.

Referring to FIG. 2, the client PC 30 is a communication terminal device, which is a well-known personal computer. The client PC 30 carries out processing such as forming and storing of image data or letter data. In the present embodiment, as an example, the client PC 30 is used as a communication terminal device for receiving image data scanned by an image scanner 2, image data received by facsimile, and other text data. A main control unit 101 is formed of a CPU (Central Processing Unit) specifically. The main control unit 101 is connected to each of the hardware units to be mentioned below via a bus 113, and controls the hardware units. In addition, the main control unit 101 carries out various software functions to be mentioned later on. A display 104 is a displaying device such as a liquid crystal display (LCD) or a cathode ray tube (CRT) display. The display 104 displays operational status of the client PC 30, and displays image data of an original to be transmitted, and received image data. An operation unit 105 can be a keyboard or the like. The operation unit 105 is used for inputting letter data or indication command.

ROM (Read Only Memory) 106 stores in advance various software programs that are necessary for the operation of the client PC 30 and that is to be executed by the main control unit 101. RAM (Random Access Memory) 107 is formed of SRAM (Static Random Access Memory), DRAM (Dynamic Random Access Memory), SDRAM (Synchronous DRAM) or the like. The RAM 107 is used as a working area of the main control unit 101, and stores temporary data generated when the program is executed. A hard disk drive 108 is a storage device that includes a storing medium, and stores application programs to be executed or image memory.

The image data is stored in a corresponding memory box within memory box field 8a after being scanned and converted by the image scanner 2. In the client PC 30 formed in the above-mentioned way, when forwarding an image data to the client PC 30 itself, the main control unit 101 of the client PC 30 transmits a forward indication demand signal, which includes indication data for indicating a corresponding memory box, to the main control unit 1 within the digital multifunction peripheral 20 via the LAN interface 112 and the LAN 70. Then, in response to this, the main control unit 1 receives the image data being transmitted from the digital multifunction peripheral 20 via the LAN 70, and stores the image data to the hard disk drive 9. Alternatively, the client PC 30 receives the image data or the text data being transmitted from the digital multifunction peripheral 20, and displays the data on the display 104.

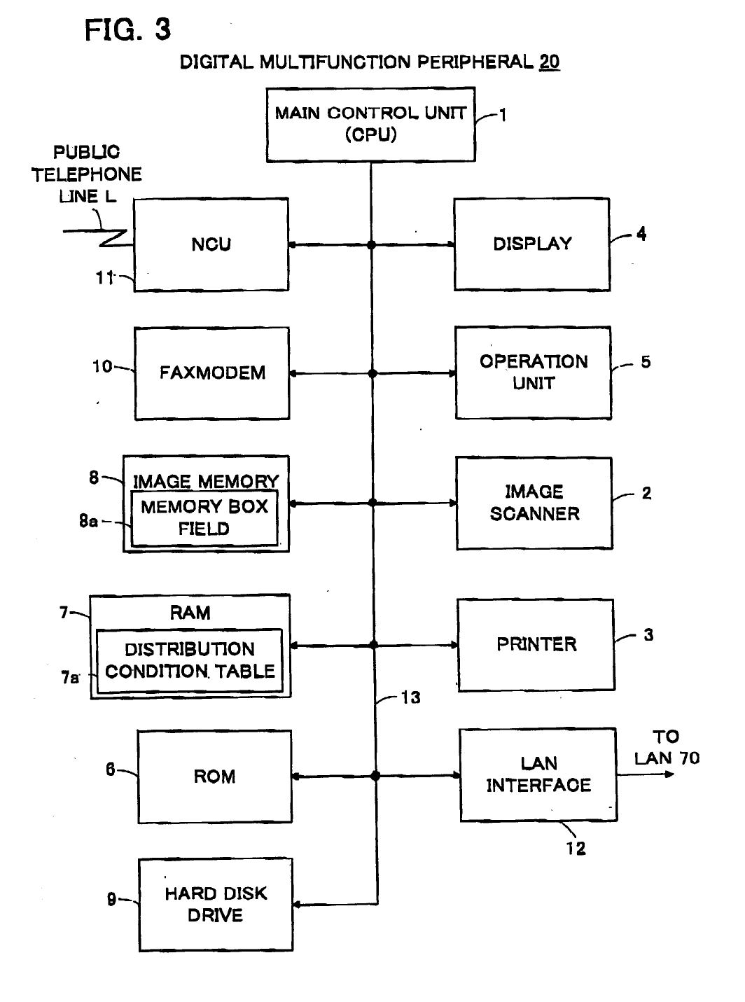

FIG. 3 is a block diagram showing the structure of the digital multifunction peripheral 20 of FIG. 1.

Referring to FIG. 3, the digital multifunction peripheral 20 includes each of the functions of Internet facsimile, copy, network printer, and network scanner, in addition to the conventional facsimile communication function such as G3 method. The main control unit 1 is formed of CPU specifically. The main control unit 1 is connected to each of the following hardware units via a bus 13, and controls the hardware units. In addition, the main control unit 1 carries out various software functions to be mentioned later on. An image scanner 2 scans an original by a scanner using CCD (Charged Coupled Device) or the like, and outputs digital image data converted in a binary of black and white or multi-color. A printer 3 is an electro-photographic type printing device or the like that includes a heater at the fuser, and starts printing to recording paper after the warming up of the heater. The printer 3 prints out as hardcopy, the image data scanned and converted by the image scanner 2, the image data or the letter data received by a facsimile communication from another facsimile machine. The printer 3 becomes on standby after printing, with the power source of the heater stops, or with voltage reduced.

A display 4 is a displaying device such as LCD or CRT display. The display 4 displays the operational status of the digital multifunction peripheral 20, or displays the image data of the original to be transmitted, and the received image data. An operation unit 5 includes various keys necessary for operating the digital multifunction peripheral 20, for example, letter keys, ten-key numeric pad for dialing, speed-dial keys, one-touch dial keys, and other various function keys. Further, by forming the display 4 to be a touch panel, a part of or all of the various keys within the operation unit 5 can be shared.

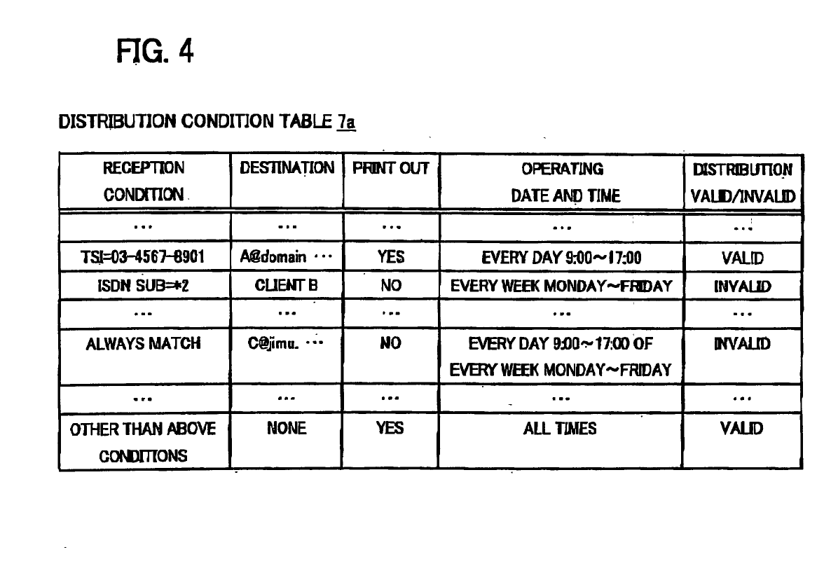

ROM 6 stores in advance various software programs that are necessary for the operation of the digital multifunction peripheral 20, and that are to be executed by the main control unit 1. RAM 7 is formed of SRAM, DRAM, SDRAM, or the like. The RAM 7 is used as a working area of the main control unit 1, and stores temporary data generated when the program is executed. The RAM 7 includes a distribution condition table 7a shown in FIG. 4. Further, in the case a flash memory is used for the RAM 7, the contents of the data are not lost even when the power source is shut off due to power failure or transferring the machine.

An image memory 8 is formed of DRAM or the like, and stores the image data to be transmitted, the received image data, or the like. The image memory 8 includes a memory box field 8a that is divided into a plurality of memory boxes corresponding to the plurality of the client PC 30. In addition, a hard disk drive 9 is a storage device having recording medium, and stores various data and program.

Faxmodem 10 is a modem connected to a public telephone line L, and includes functions of a faxmodem for G3 facsimile communication. NCU (Network Control Unit) 11 is a hardware circuit that carries out releasing and closing operations of a current loop of an analogue public telephone line L, and that includes automatic dialing function. In addition, the NCU 11 connects the faxmodem 10 to the public telephone line L when necessary. Further, the NCU 11 can be connected to a digital network (for example, ISDN (Integrated Services Digital Network) line) of a base band transmission method via a prescribed terminal adapter and DSU (Digital Service Unit).

In addition, LAN interface 12 is connected to the LAN 70. The LAN interface 12 receives signals or data from the LAN 70. Meanwhile, the LAN interface 12 transmits signals or data to the LAN 70, and executes interface processing relating to LAN communications such as signal conversions or protocol conversions.

According to the G3 facsimile communication function of the digital multifunction peripheral 20 formed in the above-mentioned way, the dotted image data forwarded from each of the clients PC 30-1 through 30-N, or the dotted image data scanned by the image scanner 2 are encoded in accordance with encoding methods of MH (Modified Huffman), MR (Modified Read), MMR (Modified Modified Read) or the like, which are defined in the standards of the facsimile communication. Then, the dotted image data is transmitted to the facsimile machine at the other end. Meanwhile, the encoded data received from the facsimile machine at the other end is stored in the image memory 8, and when necessary, the encoded data is decoded into image data and printed out by the printer 3.

In addition, according to the Internet facsimile function of the digital multifunction peripheral 20, the image data or the text data are received from another Internet facsimile machine via the Internet 90, or the image data or the text data are transmitted to another Internet facsimile machine via the Internet 90, in accordance with communication procedures such as T.37 or T.38 of ITU-T (International Telecommunications Union) Recommendation. The another Internet facsimile machine is specified by an electronic mail address, IP address, or the like. Moreover, the another Internet facsimile machine can be a client PC 30 within the LAN 70. In addition, the electronic mail attached with the image data, or the electronic mail having image data within the main text is received from the another Internet facsimile machine via the mail server device 40 and the Internet 90 by an access to the mail server device 40 by the POP3 procedure or by the SMTP procedure from the mail server device 40. Meanwhile, these electronic mails are transmitted to the another Internet facsimile machine via the mail server device 40 and the Internet 90 by an access to the mail server device 40 by the SMTP procedure.

The mail server device 40 of FIG. 1 receives the electronic mail transmitted by the SMTP communication procedure or the like from the digital multifunction peripheral 20 or the client PC 30. Then, after storing the electronic mail once to the storage device within the mail server device 40, the mail server device 40 transmits the electronic mail via the router device 60 and the Internet 90 to a specific electronic mail address specified in the electronic mail. Meanwhile, the electronic mail that has been transmitted from an outer mail server device is received by the mail server device 40 via the Internet 90 and the router device 60, and then stored once to the storage medium within the mail server device 40. Next, the digital multifunction peripheral 20 or the client PC 30 accesses to the mail server device 40 by the POP 3 communication procedure, and takes in the received electronic mail. Alternatively, the digital multifunction peripheral 20 receives the electronic mail that has been transmitted from the mail server device 40 by the SMTP procedure.

FIG. 4 is a view showing an example of the distribution condition table 7a which is stored in the RAM 7 of FIG. 3. The distribution condition table 7a shows the distribution condition for how to distribute data such as the received or scanned image data, or the electronic mail. Further, the data of the distribution condition table 7a is input in advance by using the operation unit 5 or the client PC 30. For the distribution condition that is to be registered, various conditions or destinations can be registered. In the example shown in FIG. 4, reception condition and operating date and time are set as the condition, and the destination of when the condition is satisfied and information showing whether or not to print out the received facsimile image data by the printer 3 to the recording paper are included. In addition, the distribution condition table 7a according to the present embodiment includes flags for validating or invalidating the distribution condition for each record of the distribution condition.

For the reception condition, a condition can be set for all information that is transmitted from transmitter terminal device (or switchboard of telecommunications firm) of the facsimile image data. For example, the condition can be set for caller ID notification or ISDN sub-address being transmitted from the switchboard at the time of an incoming call, number of the transmitter terminal being transmitted as TSI (Transmitting Subscriber Identification) signal during the facsimile procedure, or F-code sub-address and password. In addition, in the case reception can be accepted from a plurality of lines, the condition can be set for incoming line number or the like. In the example shown in FIG. 4, the reception condition is such that the transmitter terminal number being transmitted by the TSI signal is “03-4567-8901”, and the reception condition is such that the ISDN sub-address is “*2”. Moreover, various conditions can be set, such that partial information is set as the condition, or as the condition to be eliminated, for example, to set only the area code of the transmitter terminal number as the condition.

In addition, for the reception condition, other than the individual conditions mentioned above, a condition that is matched always at the time of facsimile reception (condition that covers all reception) can be set. In FIG. 4, this condition is shown as “always match”. Furthermore, among the distribution conditions that are stored in the distribution condition table 7a, a condition can be set for the case when the distribution conditions excluding this condition are not matched. In FIG. 4, this condition is shown as “other than above conditions”.

For distribution operating date and time, a time slot for carrying out distribution can be set as the condition. In the example shown in FIG. 4, a condition for designating distribution within office hours of between 9 o'clock and 17 o'clock, a condition for designating weekdays of Monday through Friday, and condition of a combination of these are shown. These conditions can be designated whether to be valid repetitively for every day, every week, every month, and every year, or whether to be valid only for the set time. In the example shown in FIG. 4, the condition is valid repetitively for “every day”, “every week”. Moreover, the designation can be a combination of these hours, days of week, or dates, and such an example of a combination is shown in FIG. 4. In addition, a time slot for not carrying out distribution can be designated. Furthermore, as shown “all times” in FIG. 4, limitation to time slot can be not made.

For destination, various information for specifying the destination can be set. For example, when distributing to client PC 30 on the network such as the LAN, an electronic mail address, the user ID, or the like can be set. If the device is to be specified, the IP address can be set. Moreover, in the case of carrying out facsimile distribution via the public telephone line L, the facsimile number can be set. Further, information for specifying a destination corresponding to the communication protocol with the destination can also be set. In addition, a group of destinations can be set, for example, setting a domain when designating the electronic mail address. Further, a plurality of destinations can be set for the destination, and in such a case, the destinations of different communication protocols can be intervening.

The information showing whether or not to print out to a recording paper shows whether or not to print out the received facsimile image data by, for example, image printing unit 3 or a printer on the LAN 70 that is set in advance. In the case a plurality of matching distribution conditions exist, if it is designated to print out for at least one condition, the received facsimile image data is printed out. Moreover, the condition for printing out can be designated separately, for example, to print out a number of copies for only the number of distribution condition that is designated to be printed out. Further, even in the case it is designated not to print out for the matching distribution condition, when the received facsimile image data cannot be distributed to the destination that is set in the distribution condition, printing can be carried out regardless of the setting.

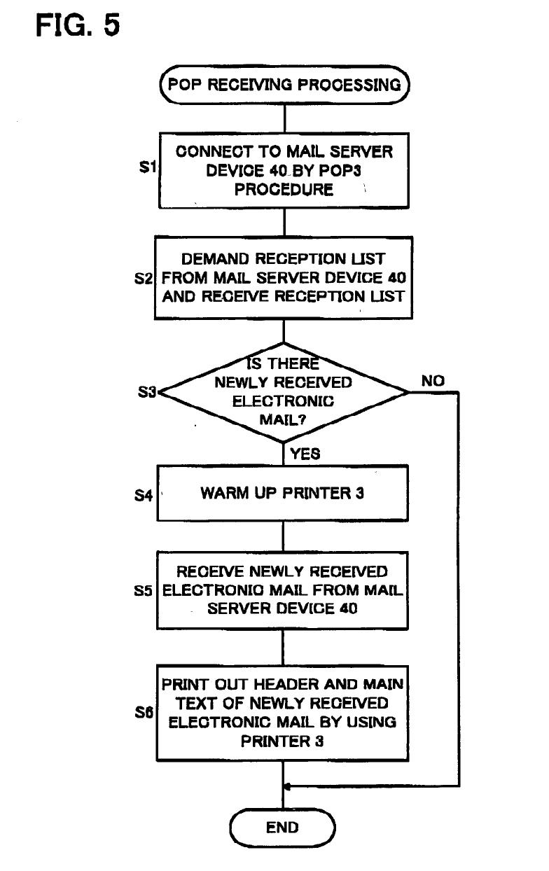

FIG. 5 is a flowchart showing POP receiving processing according to an embodiment of the present invention that is to be carried out by the main control unit 1 of the digital multifunction peripheral 20 of FIG. 3.

Referring to FIG. 5, first, in step S1, a connection is made to the mail server device 40 by the POP3 procedure. In step S2, a reception list is demanded from the mail server device 40, and the reception list is received from the mail server device 40. Then, in step S3, it is determined whether or not there is a newly received electronic mail in accordance with the received reception list. When YES is selected, it proceeds to step S4, and when NO is selected, the POP receiving processing is ended. In the step S4, the fuser of the printer 3 is warmed up. In step S5, the newly received electronic mail is received from the mail server device 40. In step S6, the newly received electronic mail is printed out to a recording paper by using the printer 3. Then, the POP receiving processing is ended.

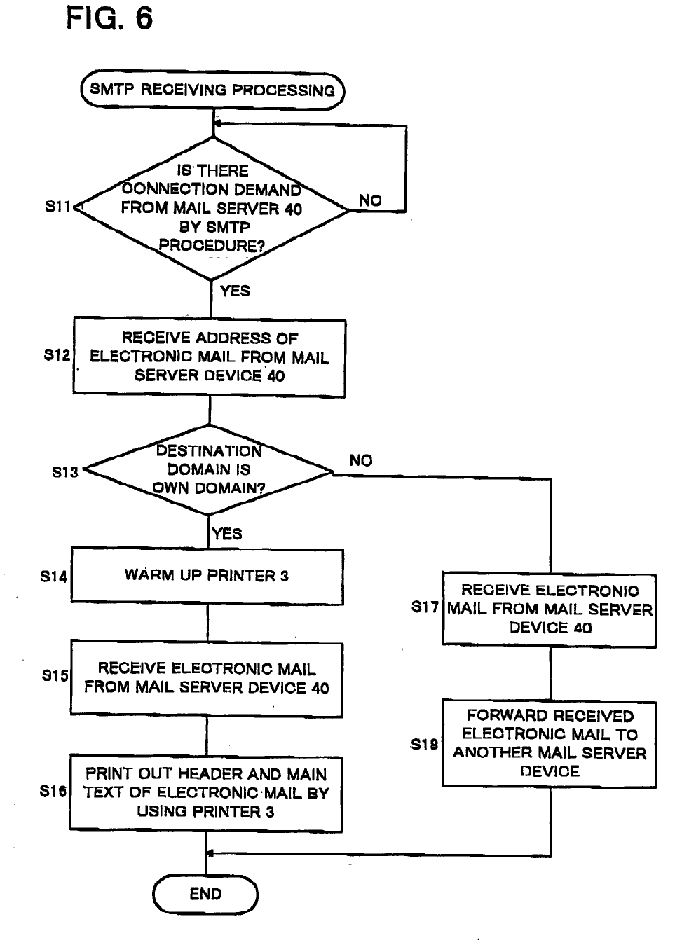

FIG. 6 is a flowchart showing the SMTP receiving processing according to an embodiment of the present invention that is to be carried out by the main control unit 1 of the digital multifunction peripheral 20 of FIG. 3.

Referring to FIG. 6, in step S11, it is determined whether or not there has been a connection demand from the mail server device 40 by the SMTP procedure. The processing of the step S11 is repeated until YES is selected. Then, when YES is selected, in step S12, the destination domain of the electronic mail is received from the mail server device 40. In step S13, it is determined whether or not the destination domain is the domain of the digital multifunction peripheral 20, in accordance with the destination domain of the received electronic mail. When YES is selected, it proceeds to step S14, and when NO is selected, it proceeds to step S17. In the step S14, the fuser of the printer 3 is warmed up. In step S15, the electronic mail is received from the mail server device 40. In step S16, the electronic mail are printed out by using the printer 3. Then, the SMTP receiving processing is ended. Meanwhile, in the step S17, the electronic mail is received from the mail server device 40. In step S18, the received electronic mail is forwarded to another mail server device that is shown by the destination domain of the received electronic mail. Then, the SMTP receiving processing is ended.

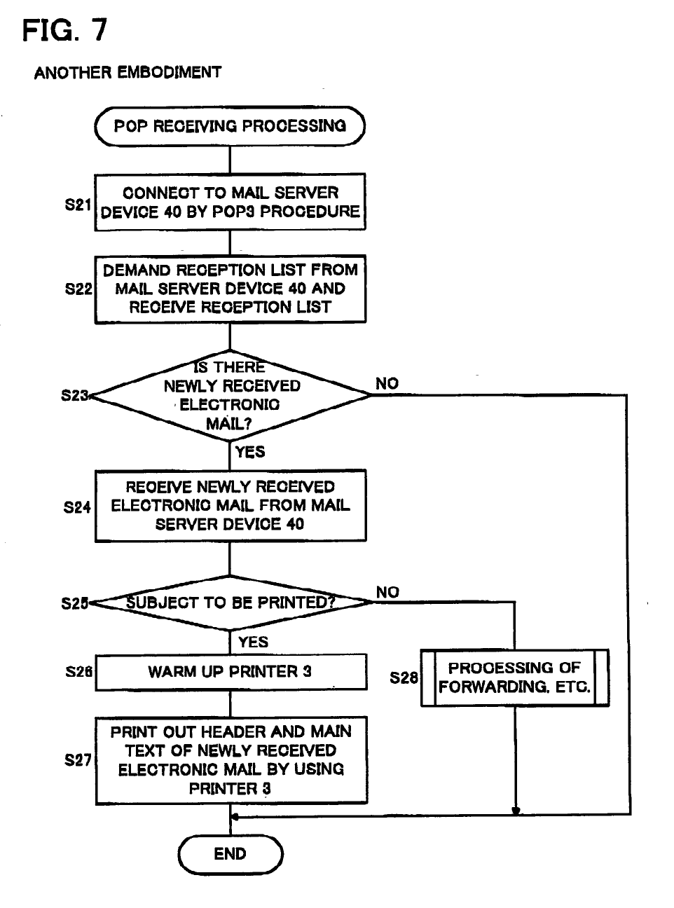

Next, control processing of warming up according to the second embodiment of the present invention will be described. In this embodiment, the main control unit 1 determines whether or not to print out the data in accordance with the distribution condition table 7a of FIG. 4. When the main control unit 1 determines that printing is necessary, the main control unit 1 controls to start the warm up operation of the fuser of the printer 3. Then, after receiving the data and the warm up operation has been completed, the main control unit 1 controls to start printing the data to the recording paper. The control processing is shown specifically in FIG. 7 through FIG. 9.

FIG. 7 is a flowchart showing the POP receiving processing according to the second embodiment of the present invention that is to be carried out by the main control unit 1 of the digital multifunction peripheral 20 of FIG. 3.

Referring to FIG. 7, in step S21, a connection is made to the mail server device 40 by the POP3 procedure. In step S22, a reception list is demanded from the mail server device 40, and the reception list is received from the mail server device 40. Then, in step S23, it is determined whether or not there has been a newly received electronic mail in accordance with the received reception list. When YES is selected, it proceeds to step S24, and when NO is selected, the POP receiving processing is ended. In the step S24, the newly received electronic mail is received from the mail server device 40. In step S25, it is determined whether or not the newly received electronic mail is subject to be printed, in accordance with the distribution condition table 7a of FIG. 4. When YES is selected, it proceeds to step S26, and when NO is selected, it proceeds to step S28. In the step S26, the fuser of the printer 3 is warmed up. In step S27, the newly received electronic mail is printed out to a recording paper by the printer 3, and the POP receiving processing is ended. Meanwhile, in the step S28, a processing such as forwarding shown in the distribution condition table 7a is carried out, and the POP receiving processing is ended.

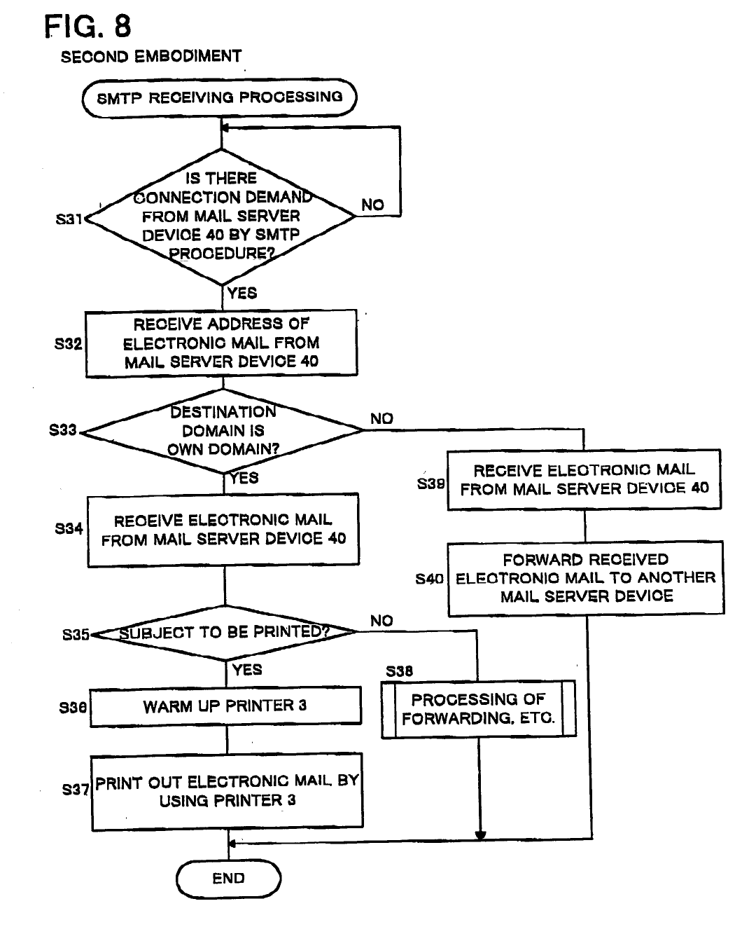

FIG. 8 is a flowchart showing the SMTP receiving processing according to the second embodiment of the present invention that is to be carried out by the main control unit 1 of the digital multifunction peripheral 20 of FIG. 3.

Referring to FIG. 8, in step S31, it is determined whether or not there has been a connection demand from the mail server device 40 by the SMTP procedure. The processing of step S31 is repeated until YES is selected. When YES is selected, in step S32, the destination domain of the electronic mail is received from the mail server device 40. In step S33, it is determined whether or not the destination domain is the domain of the digital multifunction peripheral 20, in accordance with the destination domain of the received electronic mail. When YES is selected, it proceeds to step S34, and when NO is selected, it proceeds to step S39. In the step S34, the electronic mail is received from the mail server device 40. In step S35, it is determined whether or not the electronic mail is subject to be printed, in accordance with the distribution condition table 7a of FIG. 4. When YES is selected, it proceeds to step S36, and when NO is selected, it proceeds to step S38. In step S36, the fuser of the printer 3 is warmed up. In step S37, the electronic mail is printed out by the printer 3, and the SMTP receiving processing is ended. Meanwhile, in the step S38, a processing such as forwarding, which is shown in the distribution condition table 7a, is carried out, and the SMTP receiving processing is ended.

Further, when NO is selected in step S33, in step S39, the electronic mail is received from the mail server device 40. In step S40, the received electronic mail is forwarded to another mail server device corresponding to the destination domain of the received electronic mail. Then, the SMTP receiving processing is ended.

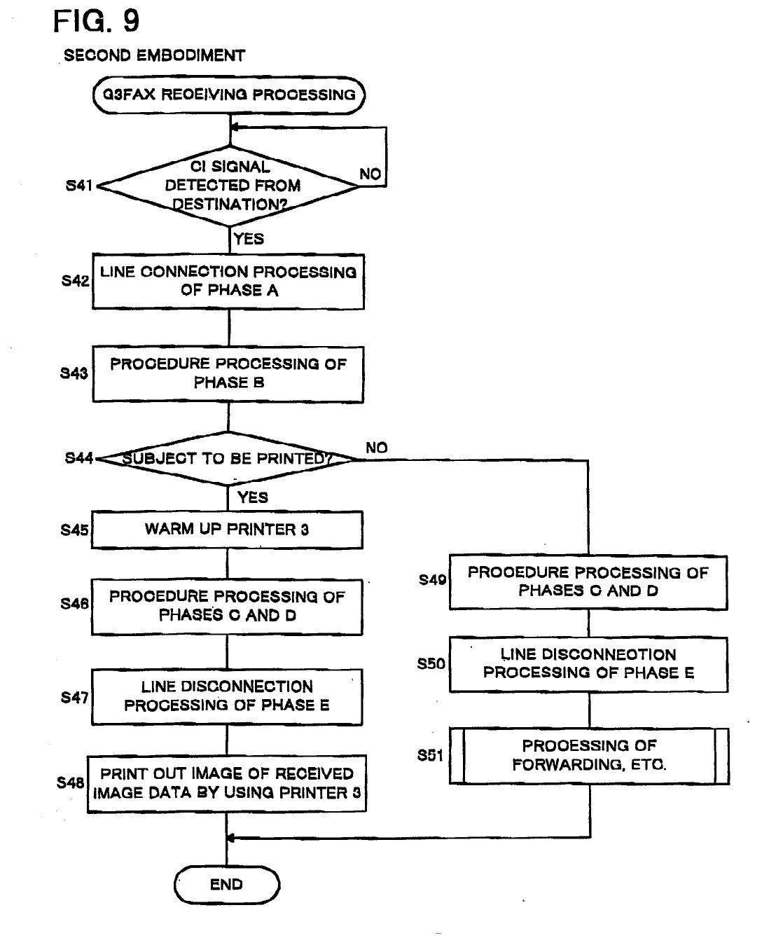

FIG. 9 is a flowchart showing G3FAX receiving processing according to the second embodiment of the present invention that is to be carried out by the main control unit 1 of the digital multifunction peripheral 20 of FIG. 3.

Referring to FIG. 9, in step S41, it is determined whether or not CI (Call Identification) signal has been detected from the switchboard. The processing of step S41 is repeated until YES is selected. When YES is selected, in step S42, line connection processing of phase A is carried out. Specifically, processing such as confirmation of called terminal is carried out in accordance with a call placing procedure. Next, in step S43, procedure processing of a phase B procedure is carried out. Specifically, processing of a determination of a communication mode, a phase adjusting, or a training is carried out. Then, in step S44, it is determined whether or not the received image data is subject to be printed in accordance with the distribution condition table 7a of FIG. 4 (specifically, in accordance with transmitter information or destination information). When YES is selected, it proceeds to step S45, and when NO is elected, it proceeds to step S49.

In the step S45, the fuser of the printer 3 is warmed up. In step S46, procedure processing of phase C and phase D are carried out. Specifically, receiving of a message that is an image data, and processing for confirming the completion of receiving are carried out. Then, in step S47, line disconnection processing of phase E is carried out. In step S48, the image of the received image data is printed out to a recording paper by using the printer 3, and the G3FAX receiving processing is ended.

Meanwhile, when NO is selected in the step S44, in step S49, procedure processing of phases C and D are carried out. Then, in step S50, line disconnection processing of phase E is carried out. In step S51, processing such as forwarding shown in the distribution condition table 7a of FIG. 4 is carried out, and the G3FAX receiving processing is ended.

Furthermore, the control processing for the warming up according to the third embodiment of the present invention will be described. In this embodiment, the processing of a determination branch based on the distribution condition table 7a included in the second embodiment can be changed to be carried out either before receiving the data or after receiving the data, in accordance with a plurality of reception methods such as the POP receiving processing, the SMTP receiving processing, or the G3FAX receiving processing. For example, in the G3FAX receiving processing, the processing of the above determination branch is carried out when receiving the image data of one page or all pages. Meanwhile, in the POP receiving processing or the SMTP receiving processing, when there is a newly received electronic mail, the processing of the above determination branch is carried out after receiving the electronic mail. Therefore, by carrying out the most suitable warming up of the electro-photographic type printer 3, unnecessary warming up can be eliminated, power consumption can be reduced, and printing time can be reduced.

Furthermore, according to the fourth embodiment of the present invention, for the same receiving processing, the user can set selectively by using the operation unit 5 to include the processing of determination branch and not to include the processing of determination branch based on the distribution condition table 7a. Specifically, in the POP receiving processing, the user can set selectively by using the operation unit 5, either the processing of FIG. 5 or the processing of FIG. 7. In addition, in the SMTP receiving processing, the user can set selectively by using the operation unit 5, either the processing of FIG. 6 or the processing of FIG. 8. Furthermore, the user can set the processing selectively by using the operation unit 5 according to a plurality of reception methods. Therefore, by carrying out the most suitable warming up of the electro-photographic type printer 3, unnecessary warming up can be eliminated, power consumption can be reduced, and printing time can be reduced. In addition, the timing for warming up the printer 3 can be set by the user. As a result, the most suitable warming up can be carried out according to the type of usage of the user, and energy saving effect can be improved.

In the digital multifunction peripheral 20 having Internet facsimile function, when printing out the received electronic mail during a sleep mode or an energy saving mode of the printer 3, warming up becomes necessary, and it requires time for printing. However, even if the warming up is started at the same time as the start of reception, when an electronic mail that is to be printed is not received, unnecessary power is used. In the present embodiment, to solve such a problem, the following processing is carried out. (1) In the case of receiving by the POP3 procedure, a connection is made to the mail server device 40, and when there is a newly received electronic mail in the mail box that is to be downloaded (YES in step S3 of FIG. 5), the printer 3 is warmed up (step S4). (2) In the case of receiving by the SMTP procedure, a connection is made, and when a command for starting transmission of the electronic mail is received from the transmitting side, the printer 3 is warmed up. (3) In the case of receiving by the POP3 procedure or by the SMTP procedure, at the time it is determined that the received electronic mail is not an electronic mail to be forwarded but is an electronic mail that is to be printed out (for example, YES in step S13 of FIG. 6), the printer 3 is warmed up. As a result, an energy saving effect is improved. (4) Furthermore, the timing for warming up the printer 3 can be set. (5) At the time FAX receiving has started, and it is determined that the condition that is to be printed is included in the original that is being received by referring to a search result of received FAX distribution setting or the like (YES in step S44 of FIG. 9), the printer 3 is warmed up (step S45). Furthermore, at the time it can be determined that the condition to be printed is included, and one valid page is received, the printer can be warmed up. As a result, energy saving effect is improved.

As described above, according to the present embodiment, by carrying out the most suitable warming up of the electro-photographic type printer 3, unnecessary warming up is eliminated, power consumption can be reduced, and printing time can be reduced.

The above embodiments describe examples of the digital multifunction peripheral 20. However, the present invention is not limited to this, and it can be applied widely to communication terminal devices including a printing unit such as a printer, for example, an Internet facsimile machine, G3 or G4 facsimile machines, and data transmission devices using a modem.

What is claimed is:

1. A communication terminal device comprising:
a receiving unit for receiving data via a network;
a printing unit for printing the data on a recording paper after carrying out a warm up operation; and
a control unit for controlling to start the warm up operation of the printing unit prior to receiving of the data, and to start printing of the data on the recording paper after receiving the data and the warm up operation has been completed.

2. A communication terminal device comprising:
a printing unit for carrying out printing on a recording paper after a warm up operation; and
a control means for controlling to start the warm up operation of the printing unit when detecting electronic mail that is to be downloaded, and to start printing of the electronic mail on the recording paper after downloading the electronic mail after the warm up operation has been completed.

3. A communication terminal device comprising:
a printing unit for carrying out printing on a recording paper after a warm up operation; and
a control means for controlling to start the warm up operation of the printing unit when detecting reception of an electronic mail, and to start printing of the electronic mail on the recording paper after receiving the electronic mail and the warm up operation has been completed.

4. A communication terminal device comprising:
a printing unit for carrying out printing on a recording paper after a warm up operation;
a determining means for determining whether or not to print data in accordance with a prescribed condition table prior to receiving the data; and
a control means for controlling to start the warm up operation of the printing unit when it is determined that printing is necessary, and to start printing the data on the recording paper after receiving the data and the warm up operation has been completed.

5. A communication terminal device comprising:
a printing unit for carrying out printing on a recording paper after a warm up operation;
a plurality of receiving means for receiving data;
a determining means for determining whether or not to print out data in accordance with a prescribed condition table;
a control means for controlling to start the warm up operation of the printing unit when it is determined that printing is necessary, and to start printing the data on the recording paper after the warm up operation of the printing unit has been completed; and
a changing means for changing to carry out determination by the determining means either before the receiving of the data or after the receiving of the data in accordance with the plurality of receiving means.

6. A communication terminal device comprising:
a printing unit for carrying out printing on a recording paper after a warm up operation;
a determining means for determining whether or not to print data in accordance with a prescribed condition table;
a first control means for controlling to start the warm up operation of the printing unit when it is determined that printing is necessary, and to start printing the data on the recording paper after the warm up operation of the printing unit has been completed;
a second control means for controlling to start the warm up operation of the printing unit without determination by the determining means, and to start printing the data on the recording paper after the warm up operation of the printing unit has been completed; and
a setting means for setting by selectively switching between a processing of the first control means and a processing of the second control means.

7. The communication terminal device according to claim 6 further comprising a plurality of receiving means for receiving data, wherein the setting means selectively switches between a processing of the first control means and a processing of the second control means in accordance with the plurality of receiving means.

8. A control method of the communication terminal device comprising:
warming up a printing unit prior to receiving data;
receiving the data; and
start printing the data after receiving the data and after warming up the printing unit.

9. The communication terminal device according to claim 1, wherein the printing unit includes a fuser which is warmed up prior to receiving the data.

10. The communication terminal device according to claim 1, wherein the printing unit is an electro-photographic type printer.

11. The communication terminal device according to claim 2, wherein the printing unit includes a fuser which is warmed up prior to receiving the data.

12. The communication terminal device according to claim 2, wherein the printing unit is an electro-photographic type printer.

13. The communication terminal device according to claim 3, wherein the printing unit includes a fuser which is warmed up prior to receiving the data.

14. The communication terminal device according to claim 3, wherein the printing unit is an electro-photographic type printer.

15. The communication terminal device according to claim 4, wherein the prescribed condition table is stored in a random access memory (RAM).

16. The communication terminal device according to claim 4, wherein the prescribed condition table indicates a distribution condition for how to distribute data.

17. The communication terminal device according to claim 5, wherein the printing unit includes a fuser which is warmed up prior to receiving the data.

18. The communication terminal device according to claim 5, wherein the prescribed condition table indicates a distribution condition for how to distribute data.

19. The communication terminal device according to claim 6, wherein the prescribed condition table is stored in a random access memory (RAM).

20. The communication terminal device according to claim 6, wherein the prescribed condition table indicates a distribution condition for how to distribute data.
